(19) United States
(12) Patent Application Publication
(10) Pub. No.: US 2025/0080221 A1
(43) Pub. Date: Mar. 6, 2025

(54) OWC FRONT END AND OWC SYSTEM

(71) Applicant: SIGNIFY HOLDING B.V., EINDHOVEN (NL)

(72) Inventors: MATTHIAS WENDT, WÜRSELEN (DE); ANDREAS FELIX ALFRED BLUSCHKE, DRESDEN (DE); CHRISTIAN JORDAN, OTTENDORF-OKRILLA (DE)

(21) Appl. No.: 18/726,516

(22) PCT Filed: Dec. 22, 2022
(86) PCT No.: PCT/EP2022/087454

§ 371 Date: Jul. 3, 2024

(30) Foreign Application Priority Data
Jan. 7, 2022 (EP) 22150497.0

(51) Int. Cl. H04B 10/116

(52) U.S. Cl. CPC H04B 10/116

(57) ABSTRACT

An Optical Wireless Communication, OWC, front end (300) comprises a reflective splitter (310). The reflective splitter (310) has a controller port (311) for optical coupling to a controller (200) which generates OWC signals, and the reflective splitter (310) has a plurality of user ports (312) for optical coupling to OWC endpoint devices (400). The reflective splitter (310) is constructed and arranged such that: light received at the controller port (311) is passed to one or more of the user ports (312) for transmission to one or more OWC endpoint devices (400) in optical wireless communication with that user port (312); and light received at any of the user ports (312a) is passed to at least one other of the user ports (312b, 312c) for transmission to one or more OWC endpoint devices (400) in optical wireless communication with that user port (312b, 312c).

### TECHNICAL FIELD

The present disclosure relates to an optical wireless communication front end for use in an optical wireless communication system.

### BACKGROUND

Optical wireless communication (OWC) refers to techniques whereby information is communicated in the form of a signal embedded in light (including for example visible light or invisible light, such as for example infrared light) emitted by a light source by modulating at least one property of the light. In this context: visible light may be light that has a wavelength in the range 380 nm to 740 nm; and infrared (IR) light may be light that has a wavelength in the range 740 nm to 1.5 mm. It is appreciated that there may be some overlap between these ranges. Depending for example on the particular wavelengths used, such techniques may also be referred to as coded light, Light Fidelity (LiFi), visible light communication (VLC) or free-space optical communication (FSO).

FIG. 1 shows schematically a typical arrangement of a known OWC system 10. The OWC system 10 comprises a controller 20 and a plurality of APs (access points) 30a-c. The APs 30 may for example be integrated into luminaires, e.g. at a ceiling or a wall of a room, at a floorlamp, etc. Each AP 30 comprises an optical front end for outputting OWC signals. The controller 20 is operatively coupled to each of the APs 30. As shown in FIG. 1, the controller 20 may also be operatively coupled to a network 50, including for example the Internet.

In operation, the controller 20 controls the APs 30 to output a respective OWC signal. Specifically, each AP 30 outputs a respective beam of light modulated to carry an OWC signal. The beam output by a given AP 30 defines a field of view (FoV) of that AP 30 (illustrated using dotted lines in FIG. 1). The FoVs generally depend on the environment in which the AP 30 is installed, and may overlap.

Also shown in FIG. 1 is a user 40 with an endpoint device 41 (EP). Examples of EPs 41 include laptops, smartphones, tablet computers, etc. The EP 41 comprises an OWC transceiver (or a separate OWC receiver and OWC transmitter) which allows it to communicate with the OWC network 10 via the APs 30. Specifically, the EP 41 is able to receive OWC signals from an AP 30 when located within the FoV of that AP 30. In FIG. 1, the EP 41 is located within the FoV of the first AP 30a and is in OWC communication with the first AP 30a. Communication from the EP 41 to the controller 20 may be provided by a non-OWC network (e.g. WiFi) or via the OWC network itself.

### SUMMARY

According to a first aspect disclosed herein, there is provided an Optical Wireless Communication, OWC, front end for use with an OWC controller which generates OWC signals, the OWC front end comprising:
a reflective splitter, the reflective splitter having a controller port for optical coupling to the controller, and the reflective splitter having a plurality of user ports for optical coupling to OWC endpoint devices;
wherein the reflective splitter is constructed and arranged such that:
   light received at the controller port is passed to one or more of the user ports for transmission to one or more OWC endpoint devices in optical communication with that user port; and
   light received at any of the user ports is passed to at least one other of the user ports for transmission to one or more OWC endpoint devices in optical communication with that user port.

Because light received at a user port is passed to other(s) of the user ports, endpoint devices in communication with the same OWC front end can communicate directly, rather than via the controller. This greatly improves the scalability of the system in which the OWC front end is implemented.

In an example, the reflective splitter is constructed and arranged such that light received at any of the user ports is also passed to the controller port for transmission to the controller. This provides for an “uplink” connection from the endpoint device(s) to the controller.

In an example, the OWC signals generated by the OWC controller are infrared OWC signals, and the OWC front end comprises a filter arranged to prevent visible light from being passed from any of the user ports to others of the user ports. This means that visible light (e.g. a reading light) in the location of one endpoint device is not transmitted to the location of another endpoint device, where it might interfere with another user, for example.

In an example, the OWC front end comprises an actuator arrangement for selectively controlling an amount of light transmitted from the OWC front end via each of said one or more of the user ports. This allows the intensity of light (e.g. visible light) from each user port to be controlled, even despite the same intensity of light being received at the controller port.

In an example, the OWC front end comprises at least one optical arrangement optically coupled to a respective at least one of said user ports for outputting light from that user port in the form of a respective beam having a field of view for reception by endpoint devices within that field of view.

In an example, the OWC front end comprises an optical amplifier for amplifying the intensity of light passed to each of the user ports before being emitted from the OWC front end for transmission to said one or more OWC endpoint devices.

In an example, the optical amplifier is arranged to amplify light received from said controller before it is passed to the controller port. This reduces the number of optical amplifiers required relative to, for example, another example in which one optical amplifier is provided per user port.

According to a second aspect discloses herein, there is provided an OWC system comprising at least one OWC front end according to the first aspect and the controller constructed and arranged to provide said OWC signals to the controller port of the reflective splitter of each OWC front end.

In an example, the controller is configured to control a device based on signals received from an OWC endpoint device via the OWC front end. The controller may operate based on commands received from the endpoint devices, or form a different external device.

In an example, said device is one or more of:
an entertainment system;
a light source constructed and arranged to provide light to the controller port of the reflective splitter for transmission from the OWC front end via said one or more of the user ports;
an actuator arrangement for selectively controlling an amount of light transmitted from the OWC front end via each of said one or more of the user ports; and
an optical arrangement for controlling a respective beam size of light emitted from the OWC front end via each respective one of the plurality of user ports of the reflective splitter.

In an example, the controller comprises a multiplexer having a plurality of inputs and an output optically coupled to the controller port of the reflective splitter of the OWC front end, the multiplexer being constructed and arranged such that light received at any of the inputs is passed to the output and light received at the output is passed to one or more of the inputs. The controller may comprise a plurality of signal generators for generating respective OWC signals and providing the OWC signals to respective inputs of the multiplexer. The signal generators may implement any known multiplexing scheme allowing endpoint devices to extract their individual OWC signal.

In an example, the OWC signals generated by the OWC controller are infrared OWC signals.

In an example, the OWC system comprises an optical amplifier for amplifying the intensity of light passed to each of the user ports before being emitted from the OWC front end for transmission to said one or more OWC endpoint devices.

### BRIEF DESCRIPTION OF THE DRAWINGS

To assist understanding of the present disclosure and to show how embodiments may be put into effect, reference is made by way of example to the accompanying drawings in which:

FIG. 1 shows schematically a typical arrangement of a known OWC system

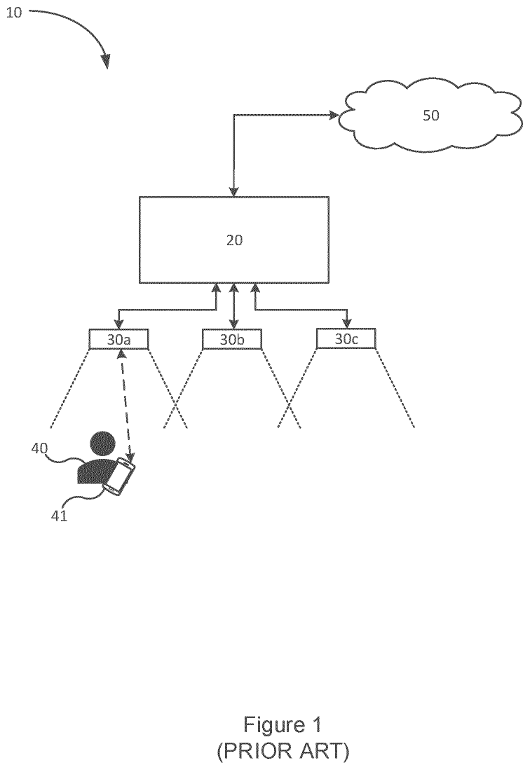

FIG. 2 shows schematically an OWC system in accordance with examples described herein;

FIG. 3 shows schematically an example of the OWC system implemented in an airplane; and

FIG. 4 shows schematically an OWC system comprising various example optional features.

### DETAILED DESCRIPTION

The present disclosure provides an OWC front end which allows EPs within the FoV of that front end to communicate with each other via OWC signals, without requiring coordination by a controller of the OWC network. This improves scalability as the processing requirements on the controller are greatly reduced, given that the controller no longer has to handle inter-EP communication. Additionally, each EP only needs an OWC connection with the OWC front end (which can also be used to communicate with the controller), meaning that the EPs do not need to be repositioned in use for communicating with another EP or with the controller. It also means that another inter-EP communication modality (i.e. non-OWC communication) is not required. As will be described below, one particularly useful implementation is in the context of large seating arrangements (e.g. on public transport such as a train or aircraft, or in a lecture or conference hall, etc.).

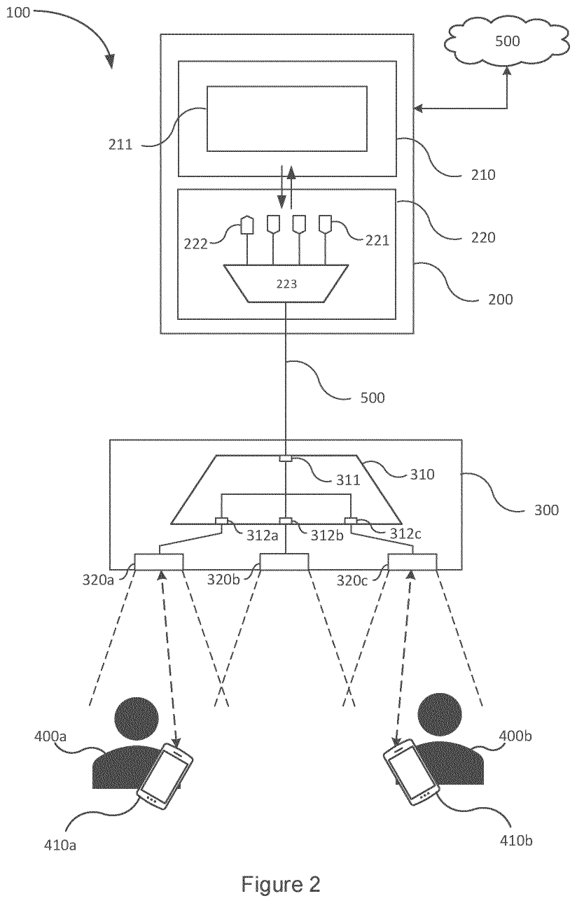

FIG. 2 shows schematically an OWC system 100 in accordance with examples described herein. The OWC system 100 comprises a controller 200 and a front end 300. The controller 200 and front end 300 are connected via an optical fibre 500. Other examples will be described later below in which there are multiple front ends 300.

The controller 200 comprises a digital part 210 and an optical part 220.

The digital part 210 may be implemented in software running on one or more processors. In particular, the digital part 210 implements an application 211 for controlling the optical part 220. The application 211 may comprise, for example, an entertainment application of an entertainment system, a conferencing application, etc. The application 211 may in examples control one or more devices such as a visible light source, an infrared (IR) light source, an ultraviolet (UV) light source, etc. This is returned to later below.

The optical part 220 is at least partly implemented in hardware for generating OWC signals (i.e. modulated light). The optical part 220 comprises a plurality of OWC signal generators 221. The signal generators 221 are controllable by the application 211 to generate respective OWC signals. Specifically, the application 211 may provide different data to each signal generator 221 to be encoded into a respective OWC signal.

The optical part 220 also comprises a multiplexer 223. The signal generators 221 are optically coupled to the multiplexer (e.g. each signal generator 221 may be optically coupled to a different respective input of the multiplexer 223 as shown in FIG. 2). The multiplexer 223 is constructed and arranged to combine the individual signals from the signal generators 221 into a combined signal, and feed the combined signal into the optical fibre 500 for transmission to the front end 300. Preferably, the signal generators 221 generate different respective signals according to a suitable multiplexing scheme, examples of which include time division multiplexing (TDM), frequency division multiplexing (FDM), and orthogonal frequency division multiplexing (OFDM). This allows a receiving device to extract the relevant signal from the combined signal, as known in the art per se.

In this example, the optical part 220 of the controller 200 also comprises a receiver 222 for receiving OWC signals. The receiver 222 is arranged to receive signals from the front end 300 via the optical fibre 500. There are various ways in which the receiver 222 can do this. In an example, the receiver 222 may be optically coupled to the optical fibre 500 itself. In another example, the receiver 222 may be operatively coupled to an input port of the multiplexer 223 as shown in FIG. 2. In the latter case, the multiplexer 223 functions as a splitter/combiner which additionally passes signals from the optical fibre 500 to all of the “inputs” of the multiplexer 223.

Turning now to the front end 300, the front end 300 comprises a reflective splitter 310 having a controller port 311, and a plurality of user ports 312. The controller port 311 of the reflective splitter 310 is optically coupled to the controller 200 (i.e. to the output of the multiplexer 223) via the optical fibre 500. In this example, there are three user ports 312a-c but it is appreciated that there may in other examples be two user ports, or four or more user ports. In general, the reflective splitter 310 may comprise any number of user ports 312. For example, the controller 200 may broadcast data (i.e. the same data stream) via an arbitrary number of user ports 312 to any number of receiving devices (EPs). Alternatively or additionally, the controller 200 may multiplex different data streams for reception by different EPs, with the signal generators 221 employing any suitable multiplexing scheme (e.g. the G.VLC standard). The multiplexing scheme may have an upper limit on the number of signals which can be multiplexed (e.g. the G.VLC standard can multiplex up to 16 signals). In these cases, the number of user ports 312 may correspond to this upper limit. However, note that this is not necessarily the case, and the number of user ports 312 can still be higher than this, as e.g. some user (EPs) may not need any connection for some time.

In this example, the front end 300 also comprises a plurality of optical arrangements 320 for outputting light from the front end 300. Each user port 312 is optically coupled to a respective optical arrangement 320 for outputting light via that user port 312. The purpose of the optical arrangements 320 is to provide an improved spatial coverage for light output from the front end 300. In particular, each optical arrangement 320 may comprise one or more lenses for forming the signal received via the respective user port 312 into a beam of light. The spatial extent of the beam defines the FoV for that optical arrangement 320. It is appreciated that the optical arrangements are optional. In an example, the optical arrangements 320 may be controllable to vary the beam size and/or shape of light emitted by that optical arrangement 320. In particular, a given beam of light has a beam direction and a beam angle (i.e. the, typically solid, angle at which the light is distributed or emitted). The optical arrangements 320 may be controllable to vary the beam angle and/or beam direction of their respective light output.

Also shown in FIG. 2 is a first user 400a and a second user 400b. The first user 400a has a first EP 410a and the second user 400b has a second EP 410b. In the example of FIG. 2, the first EP 410a is located within the FoV of the first optical arrangement 320a and the second EP 410b is located within the FoV of the third optical arrangement.

The reflective splitter 310 is constructed and arranged in the following manner:
i. light received at the controller port 311 is passed to one or more of the user ports 312 (e.g. to all of the user ports 312); and
ii. light received at any of the user ports 312 is passed to at least one other of the user ports 312.

The former (i) provides for a downlink communication from the controller 200 to EPs 410, and the latter (ii) provides for direct peer-to-peer communication between the EPs 410. The downlink communication may be used, for example, to provide media content from an entertainment system of the application 211 to an EP 410. Direct peer-to-peer communication may be used, for example, by an EP 410 to send data (e.g. one or more files) to another EP 410.

Uplink communication from the EPs 410 to the controller 200 may be provided by a non-OWC connection (e.g. WiFi). Alternatively or additionally, however, uplink communication may be provided by the OWC system 100 itself, with the optical fibre 500 providing bidirectional information flow. In such cases, the reflective splitter 310 is also constructed and arranged to pass light received at any of the user ports 312 to the controller port 311, and the optical part 220 of the controller 200 comprises the receiver 222 described above. This has the advantage of requiring less additional hardware (e.g. WiFi controllers). The uplink communication may be used, for example, to allow an EP 410 to control provide commands to the application 211, e.g. to control an entertainment system.

As mentioned earlier, one particularly useful implementation is in the context of large seating arrangements (e.g. on public transport such as a train or aircraft, in a lecture or presentation hall, etc.). In such arrangements, seats are subdivided into sections (e.g. rows or areas). It is important to be able to supply each user with a secure and performant connection to the controller 200. In these contexts, OWC communication can be preferable over other communication technologies (e.g. radio frequency, RF, communication, such as WiFi, LTE, 5G, ZigBee, Bluetooth, etc.) because these sorts of technologies generate relatively high field strengths which can influence users within the environment (even if they are not themselves interacting with the network).

As a particular example of a context in which the present arrangement may be used, consider passenger seats in an airplane. The application 211 of the controller 200 may implement an entertainment system in which media content (e.g. pictures, videos, games) is transmitted to EPs 410 via the OWC system 100.

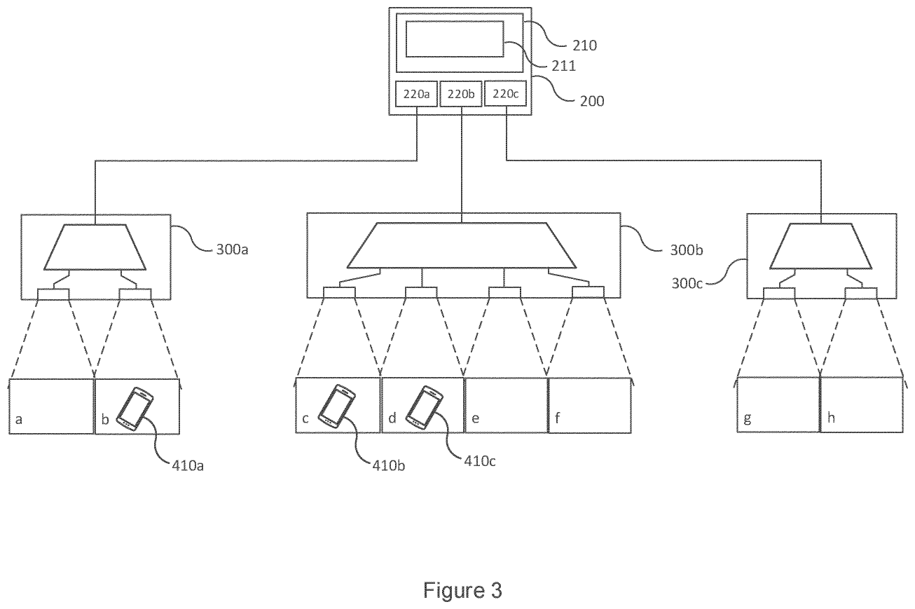

FIG. 3 shows schematically an example of the OWC system 100 implemented in an airplane. In this example, there are three front ends 300a-c. There are three optical parts 220a-c of the controller 200, each providing a respective combined signal to one of the front ends 300a-c. The application 211 controls each of the optical parts 220a-c. Similar components function as described above, and some components are not shown in FIG. 3 for clarity.

In this example, there are eight seats labelled a-h, arranged in a row. The row is split into three sections with seats a and b forming one side section, seats c-f forming the middle section, and seats g and h forming the other side section. For the purposes of explanation, a first EP 410a is located in seat b (e.g. operated by a user sitting in seat b), a second EP 410b is located in seat c, and a third EP 410c is located in seat d. It is appreciated that in other examples the arrangement of seats may be different (e.g. there may be many more rows, having different section sizes), and that there may be more or fewer EPs 410 present).

In this example, the first front end 300a comprises two optical arrangements providing OWC coverage for seats a and b respectively. That is, seat a is within the FoV of the first one of the optical arrangements of the first front end 300a and seat b is within the FoV of the second of the optical arrangements of the first front end 300a. Similarly, the second front end 300b comprises four optical arrangements providing OWC coverage for seats c-f respectively, and the third front end 300c comprises two optical arrangements providing OC coverage for seats g and h respectively.

In this example, the second EP 410b and third EP 410c are able to communicate directly via the OWC system 100 with one another because they share a front end 300b. The second EP 410b and third EP 410c are not able to communicate directly via the OWC system 100 with the first EP 410a because they do not share a front end with the first EP 410a.

In a specific example, the user of the second EP 410b and the user of the third EP 410c are able to play game using their EPs 410b, 410c with reduced lag and/or jitter, because data are transmitted directly between the EPs 410b, 410c rather than via the controller 200. In another specific example, the user of the second EP 410b may be streaming a video from the controller 200. The video may be sent from the second EP 410b to the third EP 410c via the peer-to-peer connection, which allows both user to watch the same video substantially synchronously, without requiring the controller 200 to also provide the video to the third EP 410c.

Not only does the present arrangement relieve the controller 200 from needing to coordinate communication between EPs 410, it also provides an easily scalable and adaptable OWC infrastructure. To add another row of seats, for example, to the arrangement in FIG. 3 requires only adding a new front end 300 per section of that row, and reconfiguring the controller 200 appropriately. Of course, additional controllers 200 may be provided for controlling a different set of front ends 300, e.g. in an airplane there may be one controller 200 per seat class section.

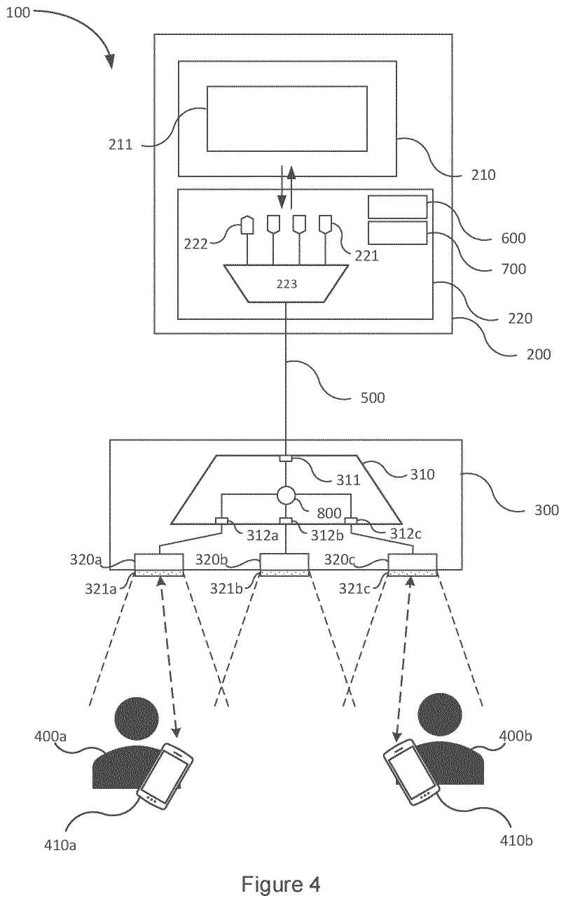

FIG. 4 shows schematically an OWC system 100 comprising various example optional features, which will now be explained in turn.

In an example, one or more visible light sources 600 may provide visible light via the front end(s) 300. The visible light source 600 may be provided, as shown in the example of FIG. 4, at the optical part 220 of the controller 200. The visible light source 600 may be, for example, arranged to provide visible light to one of the inputs 221 of the multiplexer 223 for transmission to, and output from, the front end(s) 300. Alternatively, the visible light source 600 may be provided separately from the controller 200. In any case, however, the visible light source 600 is arranged to provide visible light to the controller port 311 of the reflective splitter 310 for transmission from the front end 300 via the user ports 312.

The visible light provided by the visible light source 600 may provide a so-called “reading light” e.g. in the context of an airplane seating arrangement.

In an example, one or more ultraviolet (UV) light sources 700 may provide UV light via the front end(s) 300. The UV light source 700 may be provided, as shown in the example of FIG. 4, at the optical part 220 of the controller 200. The UV light source 700 may be, for example, arranged to provide UV light to one of the inputs 221 of the multiplexer 223 for transmission to, and output from, the front end(s) 300. Alternatively, the UV light source 700 may be provided separately from the controller 200. In any case, however, the UV light source 700 is arranged to provide

UV light to the controller port 311 of the reflective splitter 310 for transmission from the front end 300 via the user ports 312.

In the context of a seating arrangement, the UV light source 700 allows for disinfection within the seating area.

In an example, a filter 800 may be provided to prevent one or more wavelengths of light from passing between the user ports 312. The filter 800 may, for example, be constructed to block visible light generated by the visible light source 600. This is advantageous in the context of the present arrangement because light from each user port 320 may be transmitted to other user ports 320 and therefore be visible to other users 400, which is not desirable. Alternatively or additionally, the filter 800 may be constructed to block UV light generated by the UV light source 700.

In an example, one or more actuator arrangements 321 may be provided for controlling an amount of light transmitted from the front end 300 via each of the optical arrangements 320. Examples of suitable actuator arrangements include mechanically actuated filters, or LCD or electrochromic cells (also known as switchable windows). In the example of FIG. 4, an actuator 321 is provided at each optical arrangement 320 for controlling the amount of light emitted from that optical arrangement 320. This is advantageous because it allows different amounts of light emitted from each optical arrangement, in particular different amounts of visible light from a visible light source 600 as mentioned above. The actuator(s) 321 may also be manually operable.

In an example, the front end 300 and/or controller 200 may comprise an optical amplifier arranged to amplify light generated by the signal generators 221. There are various possibilities regarding the implementation of such an optical amplifier, which his therefore not shown in FIG. 4 for simplicity reasons. In an example, the optical amplifier may be arranged between the multiplexer 223 and the controller port 311 of the reflective splitter 310. This includes the optical amplifier being comprised in the controller 200 and/or the optical amplifier being comprised in the front end 300. In any event, this arrangement means that the optical amplifier amplifies light generated by the signal generators 221 before it reaches the controller port 311 for transmission to the user ports 312 and out of the front end 300. When the optical amplifier is implemented at the controller 200, an advantage is that only a single optical amplifier is required. When the optical amplifier is implemented at the front end 300, an advantage is that only a single optical amplifier is required per front end 300. In other examples, a plurality of optical amplifiers may be provided to amplify light output by each user port 312 before transmission out of the front end 300 (i.e. one optical amplifier per user port 312). An advantage of this is that each optical amplifier can operate with a lower gain, relative to the earlier examples. In yet further examples, the optical amplifier may be implemented separately from the controller 200 and front end 300, i.e. as a separate device located elsewhere on the optical cable 500. Finally, it is noted that the above-given examples are not mutually exclusive. That is, two or more optical amplifiers may be used according to any two or more of the examples given.

In an example, the controller 200 may be configured to control an external device based on signal received from the EPs 410 via the front end 300. Examples of such external devices include an entertainment system, the visible light source(s) 600, the UV light source(s) 700, the optical arrangement(s) 320, and/or the optical amplifier(s) mentioned above. For example, the controller 200 may receive one or more user commands from the EPs 410.

It will be understood that the processor or processing system or circuitry referred to herein may in practice be provided by a single chip or integrated circuit or plural chips or integrated circuits, optionally provided as a chipset, an application-specific integrated circuit (ASIC), field-programmable gate array (FPGA), digital signal processor (DSP), graphics processing units (GPUs), etc. The chip or chips may comprise circuitry (as well as possibly firmware) for embodying at least one or more of a data processor or processors, a digital signal processor or processors, baseband circuitry and radio frequency circuitry, which are configurable so as to operate in accordance with the exemplary embodiments. In this regard, the exemplary embodiments may be implemented at least in part by computer software stored in (non-transitory) memory and executable by the processor, or by hardware, or by a combination of tangibly stored software and hardware (and tangibly stored firmware).

Reference is made herein to data storage for storing data. This may be provided by a single device or by plural devices. Suitable devices include for example a hard disk and non-volatile semiconductor memory (including for example a solid-state drive or SSD).

Although at least some aspects of the embodiments described herein with reference to the drawings comprise computer processes performed in processing systems or processors, the invention also extends to computer programs, particularly computer programs on or in a carrier, adapted for putting the invention into practice. The program may be in the form of non-transitory source code, object code, a code intermediate source and object code such as in partially compiled form, or in any other non-transitory form suitable for use in the implementation of processes according to the invention. The carrier may be any entity or device capable of carrying the program. For example, the carrier may comprise a storage medium, such as a solid-state drive (SSD) or other semiconductor-based RAM; a ROM, for example a CD ROM or a semiconductor ROM; a magnetic recording medium, for example a floppy disk or hard disk; optical memory devices in general; etc.

The examples described herein are to be understood as illustrative examples of embodiments of the invention. Further embodiments and examples are envisaged. Any feature described in relation to any one example or embodiment may be used alone or in combination with other features. In addition, any feature described in relation to any one example or embodiment may also be used in combination with one or more features of any other of the examples or embodiments, or any combination of any other of the examples or embodiments. Furthermore, equivalents and modifications not described herein may also be employed within the scope of the invention, which is defined in the claims.

1. An Optical Wireless Communication, OWC, front end for use with an OWC controller which generates OWC signals, the OWC front end comprising:
a reflective splitter, the reflective splitter having a controller port for optical coupling to the controller, and the reflective splitter having a plurality of user ports for optical coupling to OWC endpoint devices;
wherein the reflective splitter is constructed and arranged such that:
light received at the controller port is passed to one or more of the user ports for transmission to one or more OWC endpoint devices in optical wireless communication with that user port; and
light received at any of the user ports is passed to at least one other of the user ports for transmission to one or more OWC endpoint devices in optical wireless communication with that user port.

2. An OWC front end according to claim 1, wherein the reflective splitter is constructed and arranged such that light received at any of the user ports is also passed to the controller port for transmission to the controller.

3. An OWC front end according to claim 1, wherein the OWC signals generated by the OWC controller are infrared OWC signals, and wherein the OWC front end comprises a filter arranged to prevent visible light from being passed from any of the user ports to others of the user ports.

4. An OWC front end according to claim 1, comprising an actuator arrangement for selectively controlling an amount of light transmitted from the OWC front end via each of said one or more of the user ports.

5. An OWC front end according to claim 1, comprising at least one optical arrangement optically coupled to a respective at least one of said user ports for outputting light from that user port in the form of a respective beam having a field of view for reception by endpoint devices within that field of view.

6. An OWC front end according to claim 1, comprising an optical amplifier for amplifying the intensity of light passed to each of the user ports before being emitted from the OWC front end for transmission to said one or more OWC endpoint devices.

7. An OWC front end according to claim 6, wherein the optical amplifier is arranged to amplify light received from said controller before it is passed to the controller port.

8. An OWC system comprising at least one OWC front end according to claim 1, and the controller constructed and arranged to provide said OWC signals to the controller port of the reflective splitter of each OWC front end.

9. An OWC system according to claim 8, wherein the controller is configured to control a device based on signals received from an OWC endpoint device via the OWC front end.

10. An OWC system according to claim 9, wherein said device is one or more of:
an entertainment system;
a light source constructed and arranged to provide light to the controller port of the reflective splitter for transmission from the OWC front end via said one or more of the user ports;
an actuator arrangement for selectively controlling an amount of light transmitted from the OWC front end via each of said one or more of the user ports; and
an optical arrangement for controlling a respective beam size of light emitted from the OWC front end via each respective one of the plurality of user ports of the reflective splitter.

11. An OWC system according to claim 8, wherein the controller comprises a multiplexer having a plurality of inputs and an output optically coupled to the controller port of the reflective splitter of the OWC front end, the multiplexer being constructed and arranged such that light received at any of the inputs is passed to the output and light received at the output is passed to one or more of the inputs.

12. An OWC system according to claim 8, wherein the OWC signals generated by the OWC controller are infrared OWC signals.

13. An OWC system according to claim 8, comprising an optical amplifier for amplifying the intensity of light passed to each of the user ports before being emitted from the OWC front end for transmission to said one or more OWC endpoint devices.
